(19) United States
(12) Patent Application Publication
(10) Pub. No.: US 2021/0035140 A1
(43) Pub. Date: Feb. 4, 2021

(54) SYSTEMS AND METHODS TO FACILITATE HYPER-PERSONALIZED MICRO-MARKETS

(71) Applicant: Boris FUZAYLOFF, Staten Island, NY (US)

(72) Inventor: Boris FUZAYLOFF, Staten Island, NY (US)

(21) Appl. No.: 16/941,950

(22) Filed: Jul. 29, 2020

Related U.S. Application Data
(60) Provisional application No. 62/880,215, filed on Jul. 30, 2019.

(51) Int. Cl. G06Q 30/02; G06F 16/2457; G06F 16/23; G06Q 40/02; G06N 20/00; G06N 5/04; G06F 40/40

(52) U.S. Cl. CPC G06Q 30/0215; G06F 16/24575; G06F 16/2379; G06Q 30/0224; G06F 40/40; G06Q 30/0236; G06Q 30/0205; G06N 20/00; G06N 5/04; G06Q 40/02

(57) ABSTRACT

A system, method, and computer program product that facilitates markets and transactions between consumers and merchants. The system includes an enrollment process for consumers and merchants, a consumer identification module, a hyper-personalized matching process, a consumer experience feed, a purchase matching module, and a reward settlement module. The invention may implement artificial intelligence and machine learning methods to identify consumers who are likely to purchase a product or respond to a promotion and to identify promotions that an individual consumer will likely respond to. The invention can then present the identified promotions to a consumer in a personalized, emotionally engaging manner. If a consumer makes a purchase associated with the promotion, the system will identify the purchase and apply the purchase to the consumer's account.

### CROSS-REFERENCE TO RELATED APPLICATIONS

The present patent application claims benefit and priority to U.S. Provisional Patent Application No. 62/880,215, filed on Jul. 30, 2019, which is hereby incorporated by reference into the present disclosure.

### FIELD OF THE INVENTION

The present system, method, and computer program product relate to facilitating markets and transactions between merchants and consumers. An embodiment may implement artificial intelligence and machine learning methods to identify potential consumers, identify merchants and promotions a potential consumer may be interested in, and present the related promotions to the potential consumers in a manner uniquely tailored to an individual consumer. An embodiment may also identify purchases associated with promotions and may apply the promotion to an account associated with the consumer.

### BACKGROUND

Present state-of-the-art marketing systems fall generally along two model types: The social network model type and the search-driven model type. The social network model type typically creates a walled garden where sign-up is required. This model is free but may harvest user data in return for social collaboration services. The harvested data is made available to advertisers for targeting promotional offers, for a fee. The advertiser (or merchant) is usually charged regardless of whether a purchase is made by the consumer.

The search-driven model type is typically an open system which does not require sign-up. Merchants pay for promotions up-front based on keywords that consumers are likely to type and search for. Advertisers bid for keywords which then appear next to search results from users. Advertisers once again pay for the advertisement regardless of purchase.

Variations on these two models exist but they generally fall somewhere in between the two models. These advertising models heavily rely on acquiring a large population of users to gain a network effect. This can be inconvenient for small markets which do not require or cannot reach out to a large population. Further, merchants pay for the advertisements regardless of whether a consumer purchases their product. Also, localization is often not the primary driver in the promotion of these types of advertisements.

### SUMMARY

An exemplary embodiment may be a system, method, and computer program product that may facilitate markets and transactions between consumers and merchants, where the method can be implemented in an embedded device having limited CPU and memory resources and having a host system.

A system for facilitating a market and transactions between one or more consumers and one or more merchants is disclosed. The system includes an enrollment process, wherein consumers and merchants may enter identifying information to enroll in the system. A customer identification module is implemented, wherein the system may identify a purchase pattern information related to a consumer and produce one or more personal clusters, each of which represents an area where the consumer frequently visits and shops. A hyper-personalized matching process analyzes the purchase pattern information and personal clusters to identify one or more relevant promotions. A consumer experience feed presents the one or more relevant promotions to the consumer in a unique manner personally tailored to the consumer. A purchase matching module analyzes financial data from a bank account belonging to the consumer to identify one or more purchases made by the consumer associated with the one or more relevant promotions. A reward settlement module applies the relevant promotions to the account of the consumer by removing funds from the account of the merchant.

A method for facilitating a market and transactions between consumers and merchants is disclosed. The first step of the method is enrolling at least one merchant and at least one consumer, wherein the merchant and the consumer enter a plurality of information including bank account information. Then the method proceeds by, identifying one or more purchase patterns of a consumer and compiling the purchase patterns into a personal cluster which identifies an area where the consumer is likely to visit and shop at in the future. Finally, the method continues by matching the consumer to one or more relevant promotions, the promotions being created by the merchant for marketing purposes, and wherein the promotions are specifically selected based on the purchase patterns of the consumer, and presenting the relevant promotions to the consumer in a unique manner tailored specifically for the consumer based on a plurality of information extracted from the consumer.

A computer program product wherein one or more merchants may market or their business using one or more promotions and wherein one or more consumers may browse and view the promotions and merchants. An enrollment module receives an identifying information from consumers and identifying information from merchants, including bank information. A customer identification module extracts a set of data which is analyzed to produce a purchase pattern associated with a consumer. The purchase pattern is further presented as one or more personal clusters, each of which represents an area where the consumer frequently visits and shops. A personalized matching process compares the purchase pattern and personal clusters to the promotions to identify one or more relevant promotions. A consumer experience feed presents the one or more relevant promotions to the consumers in a unique manner, tailored to the consumer by implementing machine learning methods to create a personalized message presenting the promotions. A purchase matching module extracts financial data from the consumer to identify one or more relevant purchases associated with the promotions. A reward settlement module applies the relevant promotions to an account associated with the consumer by removing funds from an account associated with the merchant.

The computer program product includes an enrollment module, a customer identification module, a personalized matching process, a consumer experience feed, a purchase matching module, and a reward settlement module.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram illustrating a brief overview of the components of the system.

FIG. 2 is an exemplary diagram illustrating the commerce process flow.

FIG. 3 is an exemplary diagram illustrating the merchant enrollment process.

FIG. 4 is an exemplary diagram illustrating the merchant promotion and reward management system.

FIG. 5 is an exemplary diagram illustrating the Merchant Performance Management system.

FIG. 6 is an exemplary diagram illustrating the Consumer Enrollment Process.

FIG. 7 is an exemplary diagram illustrating the Know Your Customer Process.

FIG. 8 is an exemplary diagram illustrating the Hyper-personalization Matching Process.

FIG. 9 is an exemplary diagram illustrating the Consumer Experience Feed.

FIG. 10 is an exemplary diagram illustrating the Consumer Search system.

FIG. 11 is an exemplary diagram illustrating the consumer notification system.

FIG. 12 is an exemplary diagram illustrating the Host Purchase Matching Process.

FIG. 13 is an exemplary diagram illustrating the Reward Settlement Process.

FIG. 14 is an exemplary diagram illustrating Personal Clustering and Cluster Analysis.

FIG. 15 is an exemplary diagram illustrating the hyper-personalized Narrative with NLP/NLG.

FIG. 16 is an exemplary diagram illustrating the Main Logic Components of the Hyper-personalization system.

FIG. 17 is an exemplary diagram illustrating the Tokenization (UUID) system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature(s), advantage(s) or mode(s) of operation(s).

Various exemplary embodiments of the present invention will now be described in detail with reference to the drawings. It should be noted that the relative arrangement of the components and steps, numerical expressions and numerical values set forth in the embodiments are not intended to limit the scope of the invention unless otherwise specified.

Referring to the figures generally, a new system and method of marketing for commerce is disclosed. This system may focus on connecting local merchants and local consumers in micro-markets within the same locale. The system may be applied to a variety of institutions, such as banks, hotels, wholesale clubs, and any other type of institution that has both consumers and merchants where the consumers and merchants are both localized. It may be purchase driven; merchants may only pay for ads when a transaction occurs. The system may not rely on customer acquisition but may rather rely on a host's installed user base. Enrollment may be required. The system may hyper-personalize promotions with additional narratives and experience to create an emotional connection with the consumer. The system may further feature a merchant-driven reward system, such as a system which offers consumers cash back. The purchase-driven system creates additional opportunities for the merchants to offer personalized rewards to consumers who respond to the marketing campaigns.

The system may be accessed through the host's digital platform. Consumers and merchants may need to be authenticated and authorized through the host's digital platform before they can access the system.

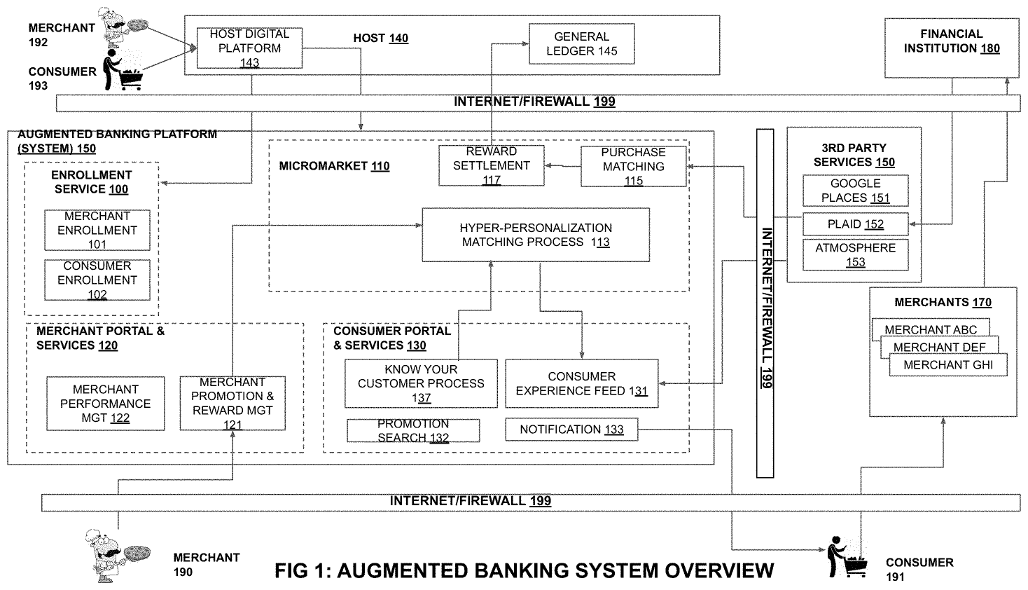

Referring to FIG. 1, an overview of the system is disclosed. In an exemplary embodiment, a host firm may enter into a contractual white-labeled arrangement with the system with the intention of augmenting revenue by facilitating commerce between the host firm's consumers and merchants. All communication between the system, the host, and any other 3rd-party services are secured through firewalls and encryption using HTTPS. The actors on the system may be:
a. A host entity, such as a financial institution, a hotelier, or any other entity that has an installed base of customers,
b. The merchants who may also be customers of the host entity,
c. The consumers who may also be customers of the host entity, and
d. The system itself.

The Merchant Enrollment Process 101 is the process by which merchants are initially connected to the system. After licensing arrangements are completed between the host entity and the augmented banking platform (henceforth known as the system), the host may embed a URL link to its digital platform to provide the access point for merchants to enroll on the system. The URL link may be usable on either a computer or a mobile device. The communication between the host and the system may be encrypted and secured using a protocol such as HTTPS. Merchants who have not yet enrolled may be able to click on a link within the system which will begin the enrollment process. The merchant may then supply the required information with guidance from the system. Towards the end of the enrollment process the merchant may accept the terms and conditions. After the enrollment process has been completed, the merchant may create, modify, delete, activate, or deactivate promotions using the Merchant Promotion and Reward Management module 121.

The Consumer Enrollment Process 102 is the process by which consumers are connected to the system. Upon enrollment in the system, consumers may receive targeted promotions from merchants whenever the System deems a promotional offer is of relevance. Relevance may be determined based on factors such as a consumer's activity, purchases, locale, and other similar data that the System may collect and analyze. As part of enrollment, the consumer may be prompted to link one or more credit or debit cards. This step may allow the system to identify transactions made with the linked card from a Financial Aggregator (such as Plaid or Yodlee) in order to (i) identify consumer purchase interest; and, (ii) process the consumer reward by correlating the purchase (transaction) with the merchant promotion (a process known as Purchase Matching). The enrollment process may also prompt the consumer to opt-in to receive electronic notifications, to allow access to the photo library stored on the consumer communication device and monitor the consumer's geo-location using consumer communication device (such as a smartphone). These ‘opt-ins’ may allow the System to create appropriate experiences, as are described more fully in the Consumer Experience Feed below. All Personal Identification Information (PII) remains with the Host Entity.

The Merchant Promotion and Reward Management Module 121 may allow merchants to setup or update promotional offers to target to consumers. Promotions may be fine-tuned to include certain triggers that may activate the promotion, such as, but not limited to, time-of-day, duration, frequency, item limit, reward limit, inventory limit, and budget limit. Promotions may not activate until the merchant generates the promotion and activates it.

The Merchant Performance Management module 122 may allow merchants to assess performance of promotions in aggergate and in detail via ‘drill-downs’ into granular, transactional data. It may also display various metrics that may provide the merchant with insight into the effectiveness of the promotion. This allows merchants to make better informed decisions regarding their promotions, thus reducing their costs and time spent related to inefficient promotions.

The “Know Your Customer” process 137 collects financial and other information that the consumer may agree to share in order to analyze and determine consumer interest with the purpose of receiving hyper-personalized, reward-bearing promotions. Information collected may include meta-data (such as geo-location data), photos, financial transactions, and any other information available. This information may allow the system to identify places a consumer has visited as well as the time visited, spending habits, and other relevant information. This data may be organized into Consumer Interest Clusters that may encapsulate in a data structure all aspects and dimensions of interest for a consumer. This is further detailed in the Hyper-personalization process where the data is used to select promotions the consumer may be interested in.

The Hyper-personalization process 113 may provide a consumer with individualized recommendations for promotions. This process takes into account active merchant promotions and the Consumer Interest Cluster for that consumer. The consumer's Consumer Interest Cluster may be a dataset that encapsulates a specific consumer's interests including the type of purchases they make, the frequency of their purchases, the locale, the price level that they tend to spend at, as well as other data points. The Hyper-personalization process then may incorporate one or more artificial intelligence algorithms in order to determine the best promoting merchant or merchants to present to the applicable consumer at an individual consumer level. The selected promoting merchant or merchants are then sent to the Consumer Experience Feed in order to programmatically craft a promotional narrative that describes the purchasing experience and service value in the most emotionally engaging way for an individual consumer.

The Consumer Experience Feed 131 may create an ordered list of textual and visual items. The list may include a narrative which may be generated using Natural Language Generation (NLG) technology. The list may also include ‘Good Memories’, which are personalized visual items such as a photo taken in proximity to the merchant's venue. Further, the list may include the promotion itself, or historical purchases made over the last month in the promotion category to provide spend indication to the consumer as well as a drill-down menu to view transactions. The Consumer Experience Feed may create positive sentiment in the consumer, through textual and visual items related to the promotion, thus increasing the rate at which a consumer completes a purchase.

The Promotion Search module 132 may allow consumers to search for merchant promotions locally available on the system by multiple search indices, such as venue name, category, amount to spend, and type of business. The search result may display a map with an indication of venues as well as a list of the merchants in order of reward amount. Each item in the list may display a Merchant Promotion created by the merchant during the enrollment period. The item is drillable, allowing a consumer to view detailed information if requested.

The Notification module 133 allows for the system to send push notifications to a consumer's device. The content of a push notification may be a narrative created in the Consumer Experience Feed 131. The notification may be delivered in the device's messaging system. The consumer may then click through the notification on their device which may then redirect the consumer to the host's app, where more details may be provided regarding the promotion and a purchase may be initiated. The Notification module can increase consumer purchase rate by reminding a consumer of a desired purchase. Further, the notifications may be triggered in a variety of ways, such as by time-of-day, time elapsed since last purchase or any specific event, geo-location, another purchase, or any other possible triggers. The notifications may also be sent immediately upon their creation.

The Purchase Matching process 115 may link a consumer's purchase transaction (which is made with the consumer's enrolled credit or debit card) to a merchant's promotion for an applicable reward. The relationship may be derived using purchase transaction data from the consumer's enrolled card, the geolocation history available on the consumer device, the consumer's phone call log, or the merchant profile information captured during merchant enrollment. The matched transactions are then used in the Reward Settlement Process 117.

The Reward Settlement Process 117 may create the postings necessary to credit and debit rewards from the merchant to the consumer, from the merchant to the host (as a fee for facilitating the purchase and branding the marketplace, and from the merchant to the system, for running the marketplace. There may be three modules, one for each reward type: cashback, loyalty programs, and discounts.

The Third-Party service 150 may integrate with 3rd-party service providers to obtain data or access a service, such as a Financial Aggregator (such as Plaid or Yodlee) for historical purchase transactions with consumer enrolled credit or debit cards from an issuer Bank, or a service provider such as Google Places, Yelp, TripAdvisor, AccuWeather and others (151) that may provide merchants within a given geo-location along with detailed information about the merchants, such as prices, venue, ratings, and directions, as well as other relevant information.

The host 140 may be the party that white-labeled the system and may be identified on the system as a tenant with a unique tenant ID and tenant type. If the host is successfully authorized on the system, the system may then only require a link from the host to the system to be shown on the host's digital platform 143 to access the system through a secure HTTPS URL link. The host's credential may be an integral part of the host's consumer application.

The host 140 may be a firm that operates within local communities, such as a small or large business. The host 140 may be a bank or hospitality firm that can benefit from facilitating micro-markets for its consumer base. A micro-market may bring focused capabilities to help increase local commerce firm's customers as well as generate additional revenue and brand loyalty. The micro-market may be designed to work best with the Host's existing base of customers that may consist of both consumers and merchants, who may benefit if there were a marketplace where they could connect and buy and sell to each other. The system may provide this micro-market along with differentiating features such as hyper-personalized promotions and a merchant-driven promotion model where merchants only pay for Ads(promotions) when a purchase is made. Depending on the Host's specifics, the merchants may incentivize the consumers with purchase-driven rewards in a number of ways, including cashback, Host's loyalty points, or discounts.

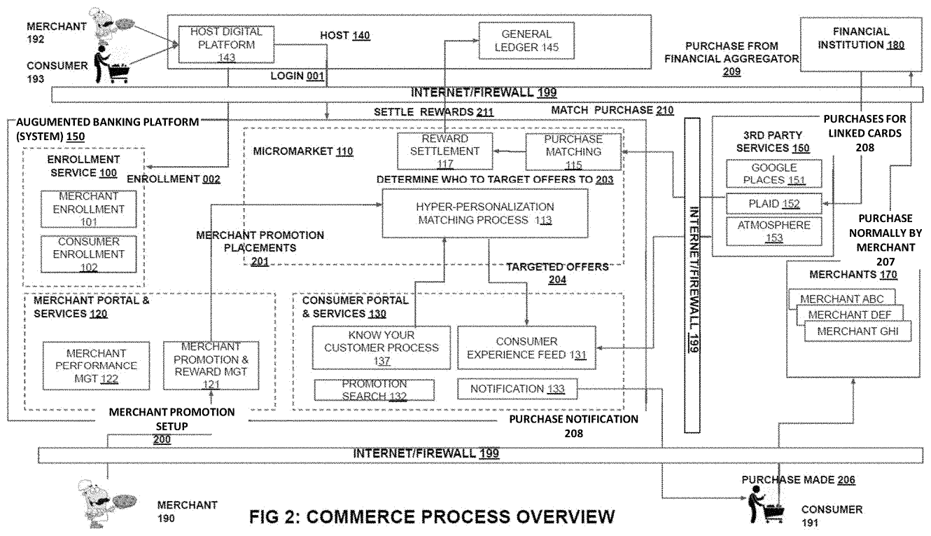

Referring to exemplary FIG. 2, an overview of the commerce process is shown. The consumers may be enrolled 002 in order to participate in the micro-market through the Host's web or mobile application. The entry point for both types of customers may be the Host Digital Platform 143, where a secure HTTPS may link to the system and redirect to the enrollment process for either consumers or merchants to enroll.

The merchant promotion setup process 200 allows merchants to create promotion campaigns. Promotions may be tailored at granular levels such as time-of-day, days-in-effect, promotion budgets and/or for monetary and inventory limits. Once created, a merchant may generate one or more promotions. Activating a promotion may make it available for the Hyper-personalization Promotion Matching process to start targeting consumers.

The Hyper-personalization Promotion Matching Process 203 may take in active merchant promotions and create a match with consumers that may have an interest in the promotion. Interest in the promotion may be determined by a set of dimensions resulting from the Know Your Customer Process that is also fed into the Hyper-personalization Matching process. The output of the Hyper-personalization promotion matching process 203 may be a set of consumers eligible to be targets for the promotion.

The Consumer Experience Feed may receive the result of the hyper-personalization Matching process and create a new unique experience for the consumer. The experience may include a hyper-personalized narrative, visual elements (such as photos taken by the consumer near the merchant venue) which may remind the consumer of a memory associated with the purchase transaction. The experience may also highlight the amount spent on the particular category with an indication including automatically calculated budgetary boundaries, along with the promotion for new experiences. This may generate a positive emotional response to the promotion, thus increasing the likelihood that a consumer will complete a purchase.

The notification process 205 may be implemented once the Consumer Experience Feed is generated. The notification may display the experience including the promotion, a narrative, a memory, and purchase history trends. The consumer may click the promotion to view a detailed description of the merchant's offering which may include the merchant review rating and other relevant details. The consumer may use a card that was linked during the enrollment process in order to receive the stated merchant reward.

Once a purchase is made 206, a traditional payment process may commence. The system may not be involved in the traditional payment process, however, the transaction may become available in the Financial Aggregator, if the consumer uses a linked card to pay for the purchase. The system then may pull the data in order to perform a reward settlement for the parties involved in the transaction.

The purchase may be pulled from the financial aggregator 209 to perform the Purchase Matching Process 210.

The Purchase matching Process may correlate data from promotions and the transaction. This may ensure that rewards are properly given to the consumer. The Purchase Matching process may combine data from multiple sources, such as Google Places for merchant venue data, the consumer's device logs, the merchant's profile data, and transaction data from a financial aggregator. Once transactions are matched, the Reward Settlement 211 may take place.

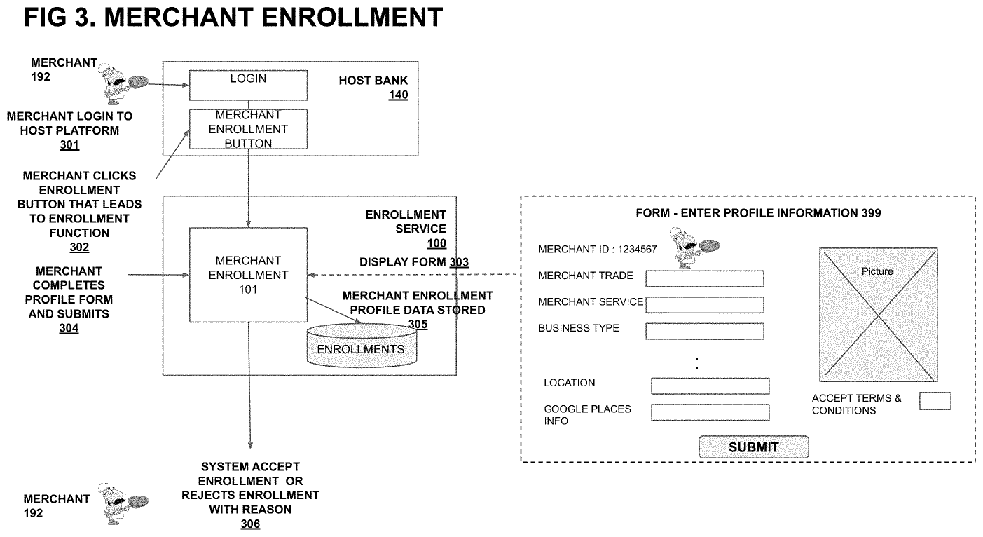

The Rewards Settlement 211 may ensure that all participants receive or pay out their rewards appropriately. The consumer may receive the reward, the merchant may pay out the rewards, and the host and the system may receive a fee for facilitating the process. These activities may result in an account posting generated by the system and may be transmitted to the Host's General Ledger system. Referring now to exemplary FIG. 3, the Merchant Enrollment process is described in detail. Merchants may be active commercial clients of the host bank and may also be up to date with the host bank's compliance standards in order to participate. Merchants may be required to have a digital account with the host bank and may be required to login 301, enroll in the host bank's service 302, among other possible steps. The enroll service 302 may direct the user to an enrollment service which may execute the Merchant Enrollment Function that may display the enrollment form 303. The enrollment for 303 may contain the following fields:
1. Host ID by which the System identifies the Host
2. Merchant ID by which a merchant is uniquely identified by a host
3. Merchant Name by which a merchant is known to the host
4. Merchant “trade” name by which a merchant is known to the public
5. Merchant “service” name by which a merchant is known to the credit card processing network, or a name which appears on a credit card transaction
6. Merchant type of business (restaurant, barber shop, flower store, etc)
7. Merchant category of business as it relates to Consumer spend category (e.g. Food & Drink, etc)
8. Merchant price-level, consumer review rating, and all other information available via Google Places
9. Merchant's physical location of where the service is provided—address and geo-locaiton
10. Phone
11. Hours of operation
12. Merchant Profile Photo
13. Merchant Profile Name
14. Merchant Profile Enrollment date
15. Acceptance of terms & conditions including it's version
16. Confirmation (as a fact of acceptance) of Merchant's Visual Profile that includes:
   a. a photo that Merchant selected from available photos of the venue at google places
   b. Name of venue
   c. Rating
   d. Price level
   e. Physical Address
   f. Opening hours of operation
   g. Phone number

The interaction between the host and the system and all communication may be through secure, encrypted sessions. Once terms and conditions are accepted and the form is submitted 304 by the merchant, the system may validate and store 305 the information for selective use when creating promotions. A response 306 may be sent to the merchant when information is validated.

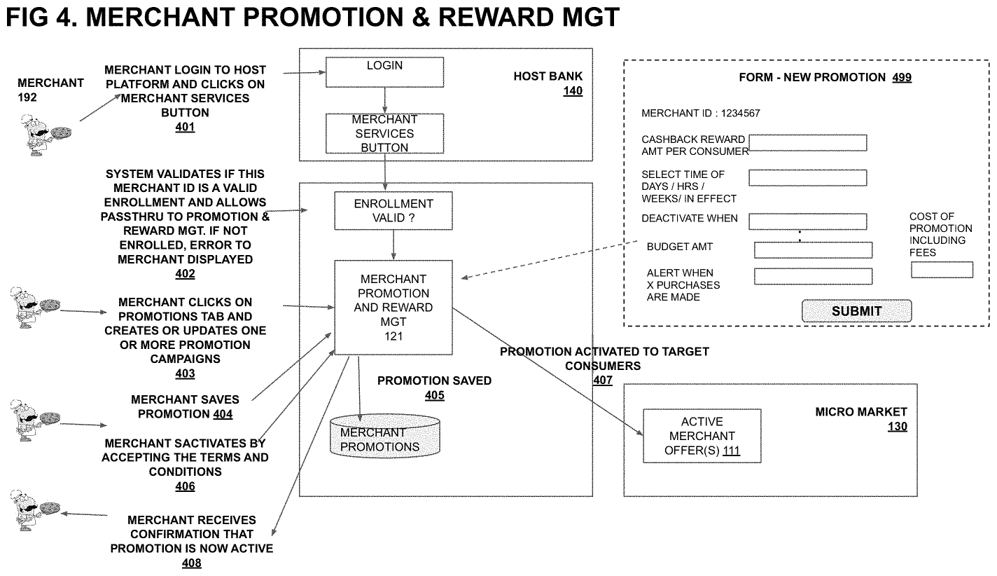

Referring now to FIG. 4, a merchant promotion and reward management system may be disclosed. The merchant may log into the host platform and access the merchant services module 401. The system may then check that the merchant is enrolled 402 If the merchant is not enrolled, a message stating instructions for enrollment may be displayed along with a link to the enrollment process. If the merchant is enrolled, the merchant may then click the promotions tab which may show a list of current promotions and their statuses (active or inactive), and a button to create new promotions. The merchant may click the new promotion button and may then be presented with a form with multiple selections and criteria for the merchant to set 403. The following information may be captured in the form:
1. Locate Merchant profile using embedded Google Places, or Trip Advisor, or Yelp API that results in displaying Merchant Profile parts of which are later used for generation of hyper-personalized promotion. The profile consists of a photo, address, name, phone number, rating.
2. Reward amount as either a percentage of the purchase amount (in the case of the Host is a Bank) or a number of loyalty points per dollar spent (in case of loyalty based Host)
3. The Host must display an equivalent dollar amount that a merchant would have to pay for each loyalty point
4. Promotion start date
5. Promotion end as one of the following:
   a. Total reward budget
   b. End date
   c. TBD by the Merchant at any time
6. One or more days of the week this promotion is in effect
7. Time period of a day during each day of the week when this promotion is in effect
8. Confirmation of the start of promotion using visual verification of Promotion Card that displays the following:
   a. Name of the venue as it's known to public
   b. Address of the venue
   c. Rating
   d. Purchase-driven Reward amount with validity period
9. Acceptance of terms and conditions
10. In the case of a Loyalty based Host, a merchant must provide a payment method to purchase the loyalty points upfront

The merchant may then save the information 405 which may be stored in the promotions database 406. The merchant may then be required to activate the promotion, by selecting it and agreeing to the terms and conditions 406, for the promotion to take effect. Otherwise, the promotion may be maintained as an inactive promotion 407. The system may enforce constraints such as prohibiting any active overlapping promotions that are from the same merchant for the same product or service over the same period of time. If the constraint is satisfied, the merchant may receive confirmation specifying the date and time the campaign will take effect as well as its duration 408.

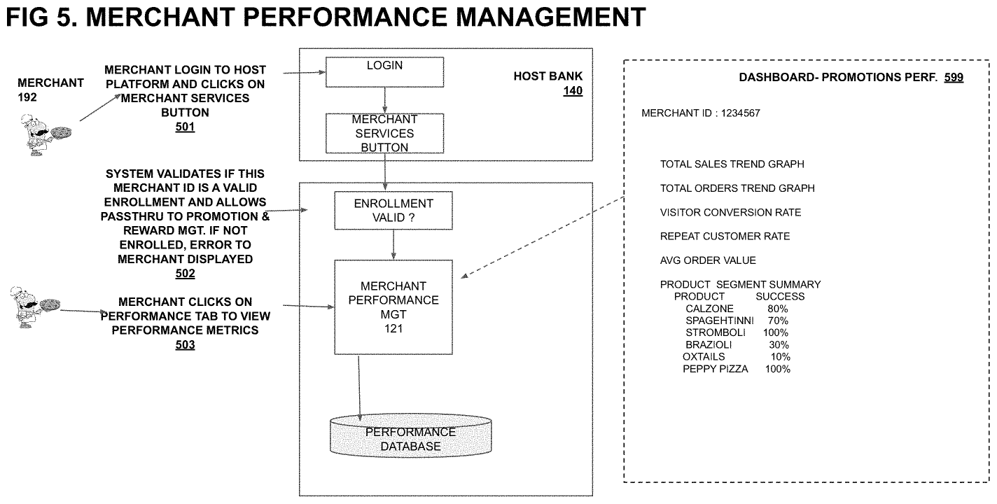

Referring now to exemplary FIG. 5, a Merchant Performance Management service may be disclosed. A merchant may log in to the host platform and enroll as a participating merchant 501 to gain access to the merchant performance management service. The system may check whether the merchant is permissioned to access the Merchant Performance Management Service, and may display a message with guidance on how to enroll if they do not have permission already 502. If the merchant does have permission, the merchant may be presented with a dashboard 503 with data such as aggregate performance figures, charts, metrics, and key performance indicators for promotion campaigns individually or in total for all campaigns. The dashboard may display single or multiple campaigns, depending on the merchant's selections. The dashboard may show trends and performance metrics 599 such as:
1) Total Sales, Total Sales by Product
2) Total Orders or orders per Product
3) Total Conversions or conversions by Product
4) Repeat Customer Rate or Customer rate by Product
5) Product Segment (Category) Summary (Product, Success Rate)
6) Avg. Order Value
7) Avg. Rating Change (+/−) Since Promotion(s)

The merchant may view additional data for each trend and view sub-categories and further, more detailed information.

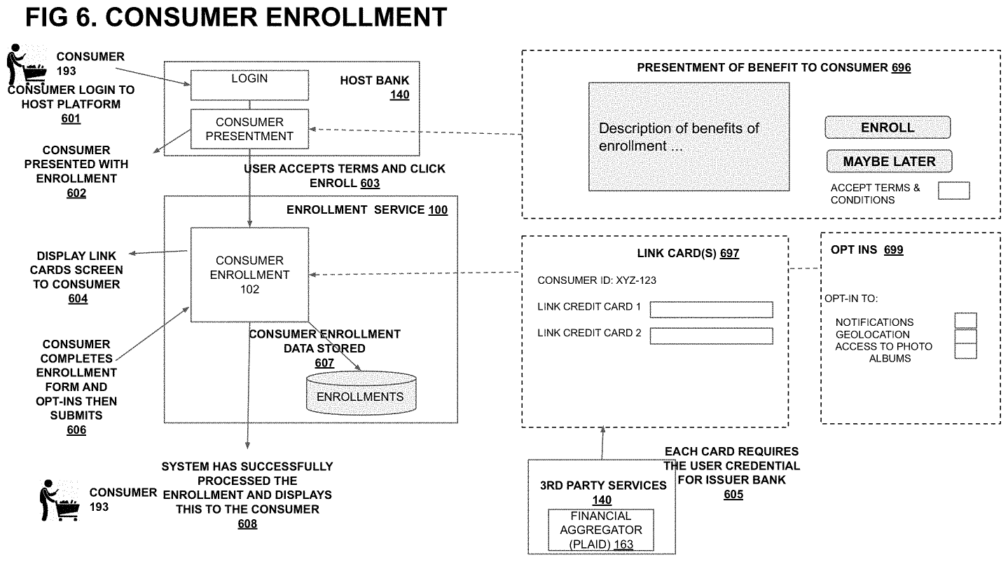

Referring to FIG. 6, the Consumer Enrollment process may be disclosed. When a consumer is already a user of the host's mobile app, the system enrollment may occur after the deployment of the integrated Augmented Banking platform through the hosting platform 601. The consumer may initially be presented with an offer to enroll 602. The initial offer may be presented with a description of the benefits of enrollment within the reward system 696. The consumer may be required to accept the terms & conditions 603. The consumer may link a credit or debit card to generate additional rewards 604. The System may utilize a third-party Financial Aggregator. Each linked card may require the login credentials from the issuing bank.

Integration with Financial Transaction aggregator service may implement the following procedure: The system may identify the bank that the card belongs to and present a login screen specific to that bank 697. The system may use a Financial Aggregator 163 to pull all the available information from that card including account credit limit, current balance, interest rate, billing cycle, minimum payment, payment history and transactions and may store it as indexed JSON. Credentials from the System and the financial aggregator may be confirmed through tokens on a secure HTTPS channel. Multi-factor authentication may be used. A consumer may be presented with a series of opt-ins 699, which may include:
a. Terms and Conditions
b. Privacy Policy
c. Opt-in for geolocation information
d. Opt-in for access to photo album
e. Opt-in for notifications
f. Other Opt-ins

Once consumer linked a card and has completed the opt-ins the Consumer Enrollment process may be complete (606) and the Know Your Customer process may begin.

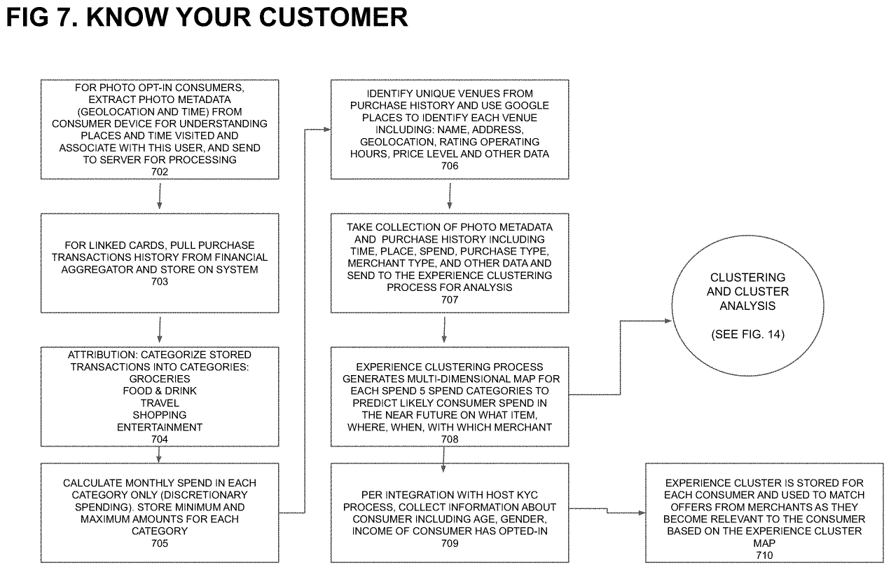

Referring now to exemplary FIG. 7, the Know Your Customer process may be disclosed. Once the consumer has enrolled, the system may collect financial data and other information that the consumer agreed to share with the system to analyze and determine consumer interest in order to receive hyper-personalized, reward-bearing promotions. The system may extract photos from the consumer's device and extract metadata from each photo 702, such as the location where the photo was taken and the time and date it was taken. This data may be associated with the user's account 707. This information is then sent to the server for processing. The consumer's credit information and purchase transactions 703 may be sent to the server, as processed from their linked credit card during the enrollment process. Purchase transaction history may be loaded from the financial aggregator from a linked card, and the system may identify the areas where a specific consumer typically spends most of their money. For example, the system may identify that a certain consumer spends their money on groceries, food and drink, travel, shopping, and entertainment, in that order from most money spent to least.

Further, the system may calculate how much a consumer might spend in each category every month on average. This may include the amount spent in each store per month, as well as information detailing the maximum and minimum amount spent in each category over a certain period of time 705. The system may further identify a list of unique venues from historical transaction information in each relevant category 706, and may load additional information about each venue using a service such as Google Places to identify information such as the name, address, location, rating, hours, and price level, as well as other relevant information.

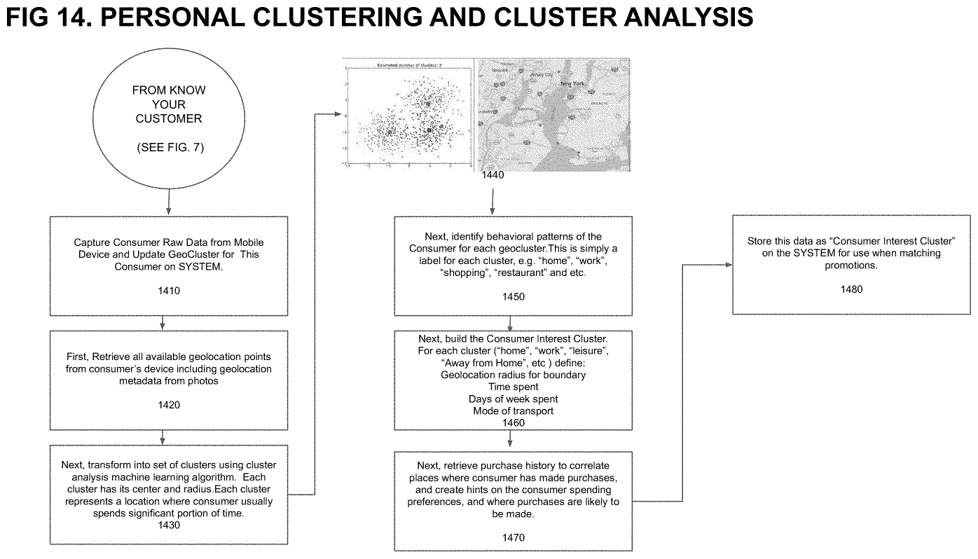

Referring to exemplary FIG. 14, the Experience Clustering process may be described. The Experience Clustering process may use all available information, such as the described historical information, to generate a multidimensional experience map using known clustering analysis techniques. The map may show consumer interests in each of discretionary spend categories described above which may include geographical area, types of merchant purchases likely to be made, median pricing level, median spending level, median rating, and the frequency and velocity of spending habits. Effectively, the Experience Clustering process may use historical information to determine the time-bound, category-bound, price-level-bound and location-bound “experience clusters” 708 that provide predictions for when and what consumers may be most interested in purchasing in the near future.

The Know Your Customer (KYC) process may also collect information about consumer age, gender, name and income information 709 which may be available from the hosting platform via integration with their KYC function. A Consumer Interest Cluster may be characterized by a geo-location that serves as a center of an area which may have an undefined radius which may be determined by the travel time rather than the distance.

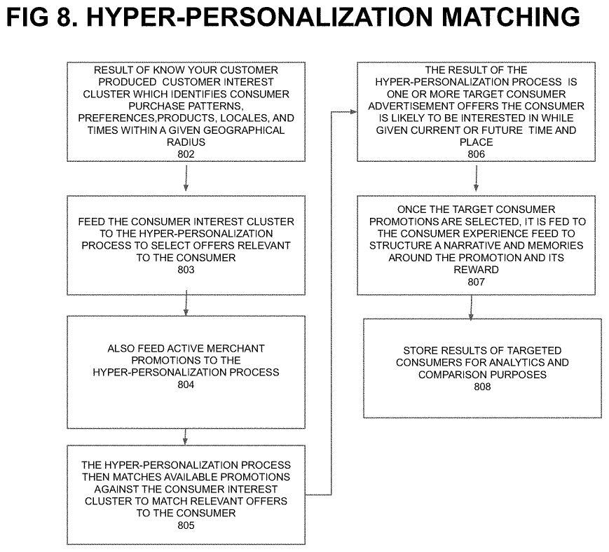

Referring now to exemplary FIG. 8, the Hyper-Personalization process is described. This process may use the result of the Know Your Customer process to provide personalized data to each consumer. The Customer Interest Clusters produced by the KYC process may be used as input 802 to the Hyper Personalization process. The Hyper-Personalization Process then may select offers based on the Customer Interest Clusters that are relevant to the consumer 803. Active merchant promotions may also be integrated into the process 804. All available promotions may be compared to the consumer interest cluster to identify offers that are relevant to the consumer 805 and may further identify how likely a consumer is to be interested in the offer or promotion 806. The relevant promotions may then be selected and fed to the consumer experience feed to structure a narrative around the promotion and its reward 807. Finally, the results of the targeted consumers may be stored 808 to provide analytic data for future comparisons.

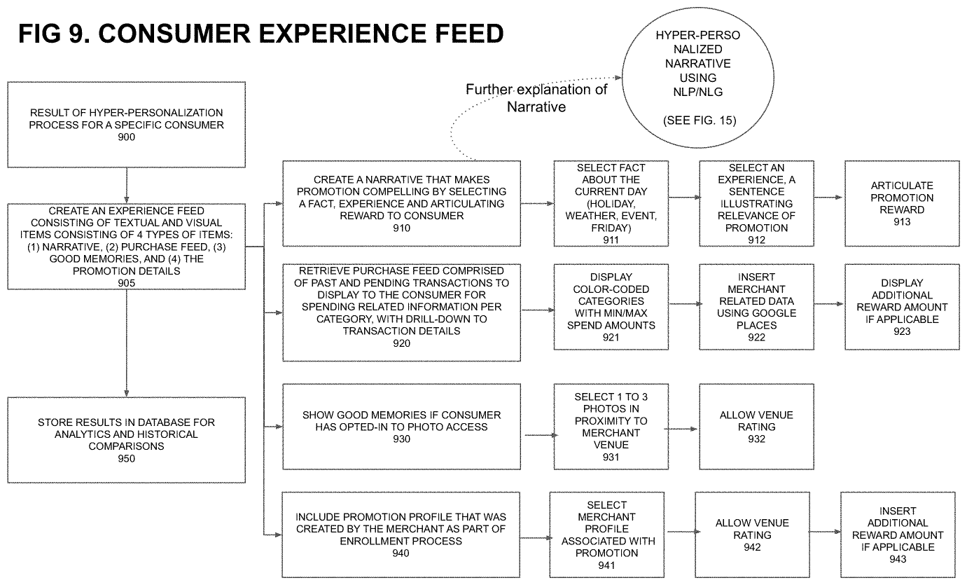

Referring now to exemplary FIG. 9, the Consumer Experience Feed may be disclosed. The Consumer Experience Feed may be an ordered list of textual and visual items such as a narrative, past purchase transactions, the promotion, and memories associated with the promotion. The Consumer Experience Feed may be populated after the Hyper-personalization process has taken place 900. The system may then create an “Experience Fee” consisting of items such as a Narrative, purchase history, Good Memories, and the promotion 905. The Narrative may be a system generated, human understood language communication with the consumer which may engage the consumer in a personable and emotionally charged way that may encourage the consumer to purchase that experience or promotion 910.

A narrative 910 may consist of 3 or more logical elements, each of which may be a sentence or a phrase. The three elements may be a fact that can reflect a piece of factual information, such as a weather condition, a day/period of the day or week (Friday night, weekend, brunch, etc.) 911 or a national regional event, such as a holiday, Academy Award night, the Superbowl, and other things of that nature 912. The fact can be any proverb that is related to the promotion. The second element may be an experience which may illustrate the experience that is being promoted and why it may interest the consumer. The third element may be the promotion itself, which may be a sentence or phrase that articulates the rewards and, if applicable, the reward period 913. To enhance emotional appeal, the promotion may be supplemented by automatically extracted emotionally appealing excerpts from a high-rated customer review of the merchant or the experience they offer.

The Consumer Experience Feed may then retrieve the purchase feed which may be displayed as a feed item that reflects pending and settled purchases made with an enrolled/linked card in one of the aforementioned top discretionary spend categories 920. Purchases may be received from a financial aggregator, such as Plaid, or from other sources. The purchase feed may include the Merchant name and rating, the amount paid, the date of purchase, the additional reward amount if applicable, a color-coded category indicator, and a short narrative describing current month-to-date expenses in this category in comparison to median spending expenditures over a past time period, such as the past 6 months.

Another item that may be displayed on the Consumer Experience Feed may be a Good Memory 930. These Good Memories may be an item that immediately follows a purchase if there are one or more photos in the customer's device that have ben taken near a merchant's store on the day of the transaction 931. The Good Memory feed item may display 1 to 3 photos as well as the ability to rate the venue or the Good Memory 932. A promotion on its own may be a Consumer Experience Feed item 940. It may be associated with a narrative or with a previous purchase.

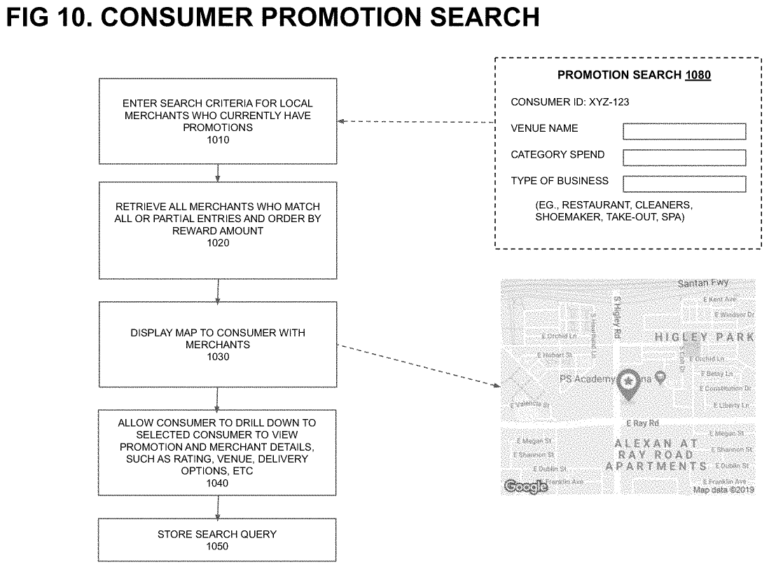

Referring now to exemplary FIG. 10, a Consumer Promotion Search function may be disclosed. This function may allow the consumer to search for local merchants who currently have active promotions. The search may be indexed by venue name, type of business, or any other contemplated search criteria 1010. Upon a user entering search criteria, the system may retrieve all merchants who match the criteria 1020. The retrieved merchants may be ordered by reward amount. Information regarding the merchant and the promotion may be displayed in the results as a drillable item that may further disclose the merchant's name, rating, a short narrative describing the experience and reward, and address with the ability to launch the device's navigation app, a phone number with the ability to place a call by clicking on it, a link to the venue's website, hours of operation, a price range that an average consumer may spend there, and a plurality of consumer reviews.

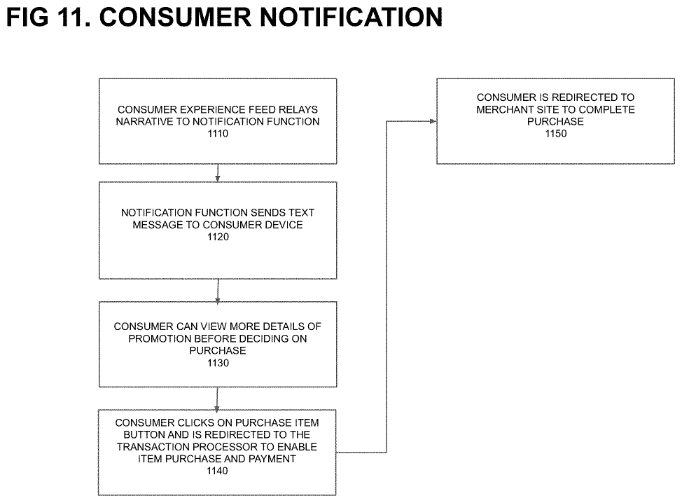

Referring now to exemplary FIG. 11, a Consumer Notification module may be disclosed. The notification module may control the push notifications sent to a consumer's device. The Consumer Experience Feed may relay a narrative to the Consumer Notification module 1110. The Consumer Notification Module may the read the user email address or any other identification of a user as identified during the Consumer Enrollment process and may then send a notification with a link to the Consumer Experience Feed 1120. The push notification may allow a consumer to view more details of a promotion before deciding to purchase it 1130. When the consumer clicks on the purchase item button, they may be redirected to the transaction processor to enable item purchase and payment 1140. The consumer may also click on the link and may be re-routed to a host's app 1150.

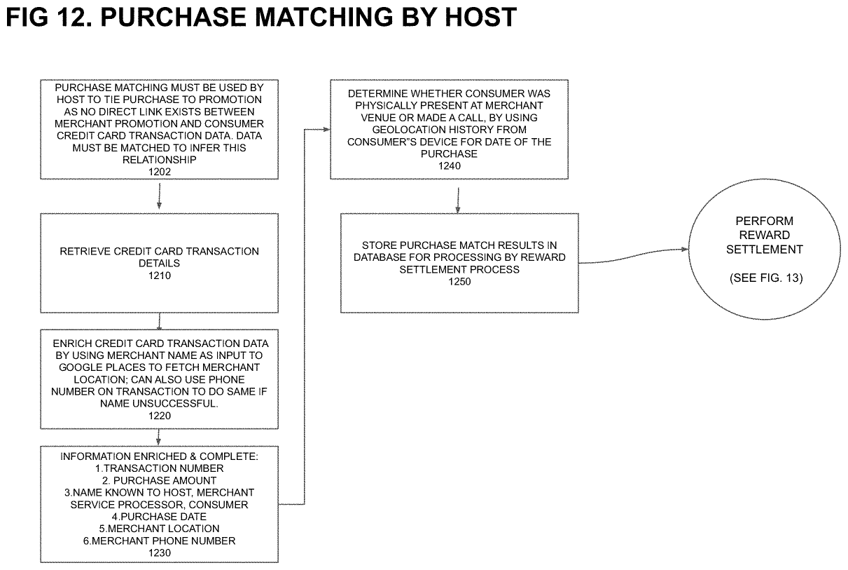

Referring now to exemplary FIG. 12, the Purchase Matching process may be disclosed. Purchase-driven rewards may depend on the type of merchant. For example, in the case of a bank, the rewards may be in the form of cashback as a Merchant-set percentage of the purchase amount. Other merchants may establish a loyalty program, where rewards may be awarded as points towards a future transaction or reward. Since a purchase may take place wholly outside of the system, the purchase matching process may need to use other criteria to determine when a consumer has made an eligible purchase to match to a promotion 1202. For example, the purchase matching process may download transactions 1210 from a consumer's enrolled credit or debit card and identify purchases from enrolled merchants as well as the amount, date, status, and name of the purchase 1230. Further, the system may use geolocation history available on a consumer's device to confirm that a consumer was physically present at the merchant's venue 1220 or may use the phone call log from the consumer's device to confirm that the consumer called the merchant to place an order 1240. When a consumer purchase is matched with a promotion, the result is stored in the database to be processed by the reward settlement process 1250.

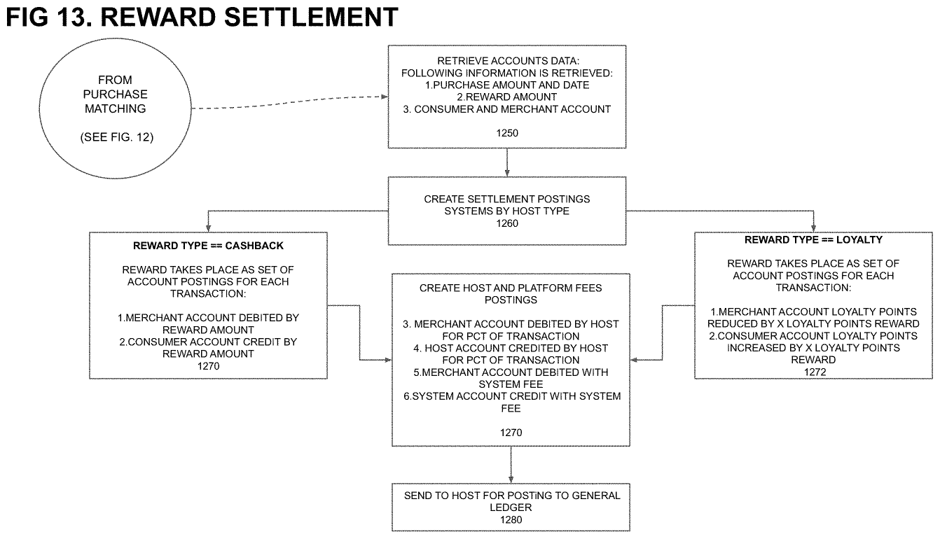

Referring now to exemplary FIG. 13, the reward settlement process may be disclosed. This process may vary according to different types of hosts. For example, if a host is a bank, merchants of the bank may offer cashback rewards, or if the host is some sort of hospitality business, rewards can be given in loyalty points. The reward settlement process may involve four participants: the host, the system, the consumer, and the merchant. Each participant may be given a unique token by the system which may consist of one or more unique IDs. For example, the consumer token may contain the Device ID, the Consumer ID, the Host ID, and the System ID. The transaction may also be given its own token that includes the tokens of the host, consumer, and merchant, as well as the payment method, consumer account, and a transaction ID. All this information may be stored in the database. The purchase matching process may organize this information in a way that is easily accessible to other modules when there is a matched purchase.

Still referring to exemplary FIG. 13, the first step of the reward settlement process may be to identify the consumer and merchant involved in the purchase 1250, as well as their accounts with the hosting enterprise. The amount and date of the purchase may be identified as well as the reward amount. Once the reward is calculated, it may be applied using a subledger posting which may reduce the account balance on the merchant's account while increasing the account balance on the consumer's account 1260. In some embodiments, the host may decide to retain a fraction of the reward amount 1270. Next, the account postings may be sent to the general ledger to apply the rewards to all participants 1280.

Referring now to exemplary FIG. 14, the personal interest clustering and cluster analysis is shown. The personal interest clustering service may be an artificial intelligence system which may assist consumers by providing personal recommendations and promotions that are highly relevant to a specific consumer. The relevance may be determined using a variety of historical data points made available to the system. The system may apply a clusterization artificial intelligence method to determine where, how, and when a consumer may have enjoyable experiences and make certain types of purchases. Data may be captured from the Know Your Customer process, as described in FIG. 7. This data may be taken from a variety of sources, including a consumer's mobile device, and uploaded to the system 1410. The information may be used to create Geoclusters 1410, which may be a geographical area with a precisely defined central point and a radius that may vary according to the user's typical activity within the area.

Within each Geocluster, the system may organize a list of enrolled merchant venues within the radius. These venues may be further filtered by their relevance, previous consumer purchases, or consumer photos taken at or near the venues. Further, the dates and times when the user has previously visited places within the Geoclusters may be recorded, as well as the category of the places visited, and the average amount spent 1420. The price level may as taken from a service provider such as Google Places may be recorded as well. Next, the raw geolocation information, as well as the photo information and other data points, may be used to form or modify the Geocluster using cluster analysis machine learning algorithms 1430. Each cluster may be illustrated on a map to show where each user spends most of their time 1440.

The Geoclusters may then be further processed and analyzed using machine learning algorithms to identify behavioral patterns of each user 1450. This may be as simple as creating labels for each cluster, such as “home”, “work”, “shopping”, “restaurant”, and other similar cluster labels. These labels may indicate when a consumer visits each cluster, such as by the day or the hour. This behavior analysis can be further quantified into a certain numerical pattern and the cluster with the highest correlation with the pattern may be identified. For example, the cluster where a user spends most of his time from 9 AM to 5 PM on working days may be identified. Using this information, the Consumer Interest Cluster may be built, which may be a group of multiple clusters along with information regarding the cluster, such as location radius, time spend, days spend, mode of transport, and other relevant data 1460.

Raw financial data may be used to enrich the cluster analytics 1470. This data may indicate useful information, such as a consumer's trends within the cluster, such as where they typically spend their money and their time. This may indicate where a consumer is likely to make purchases in the future. Finally, all of the above identified data may be stored as the Consumer Interest Cluster for the individual consumer for the system to access at a later time, such as for matching promotions to the consumer 1480.

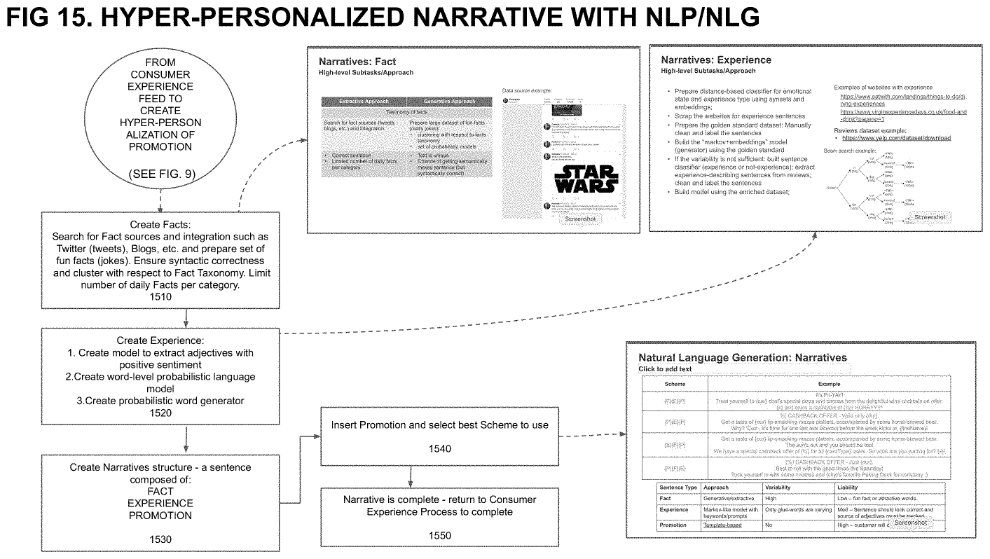

Referring now to exemplary FIG. 15, the Hyper-personalized narrative module may be disclosed. Narratives may be a collection of relevant sentences generated using artificial intelligence techniques known as Natural Language Processing (NLP) and Natural Language Generation (NLG). The narratives in the system may be composed of multiple schemes in the form of a fact, an experience, and the promotion. These may be arranged in multiple ways to create variety and keep the consumer engaged and interested in the message. Facts may be sentences that the system synthesizes which are produced by a combination of generative and extractive methods so that they always remain new, fresh, and current 1510. They may be tied to real-life events, such as the weather, sporting events, national holidays, local events, or any other contemplated notable event.

Experiences, as part of the narrative, may be sentences that describe the promoted experience in an emotionally appealing and engaging manner. This may also be produced by a generative and extractive natural language generation method or methods and may be tied to qualities of the service or product being promoted 1520. The promotion, as part of the narrative, may be a sentence that clearly describes the financial incentive associated with the promotion. This may include a description of the reward, the amount, the period it is available, as well as any other contemplated benefits. The promotion sentence or phrase may be system generated using a well-defined template or natural language processing method with a set of relevant quantitative parameters sourced from the merchant as the reward parameters 1540.

The narrative structure may be created by the natural language generation algorithm 1530. Multiple promotions may be inserted into the same or similar narrative structures for different consumers. Once a promotion is inserted into the narrative structure, the Consumer Experience Process may then send the promotion to the targeted consumer.

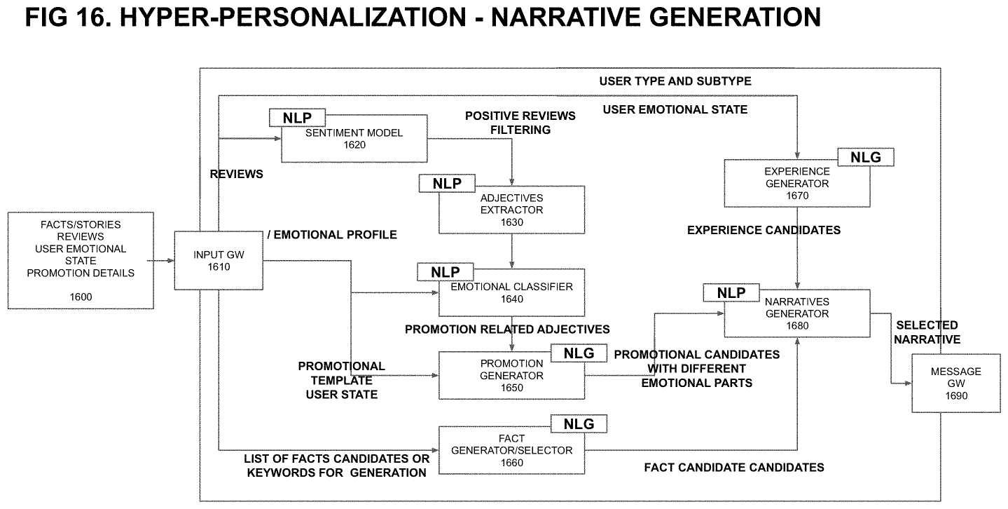

Referring now to the exemplary embodiment in FIG. 16, FIG. 16 may further illustrate an exemplary narrative generation in the hyper-personalization process. Information such as facts, stories, reviews, and other content created by the consumer may be identified 1600. This user content may identify a user emotional state and promotion details, and may be input into the generation module 1610. A natural language processing algorithm may implement a sentiment model 1620 in order to identify sentiment correlated with a user. For example, the sentiment model may process a review written by the user to identify if the review is positive or negative. An adjective extractor 1630 may also be implemented by the natural language processing algorithm. Next, an emotional classifier 1640 may identify emotions associated with the adjectives and sentiment. The promotion generator 1650 may identify one or more promotions based on the identified adjectives. A natural language generating algorithm may generate or select promotions using the promotion generator. Next, a narrative generator 1680 may identify and present narratives based on the promotion generator 1650.

Alternatively, the input 1610 could identify facts related to the consumer. A natural language generator may then promulgate or select from the facts in a fact generator/selector module 1660. The fact generator/selector module 1660 may then feed that information into the narratives generator 1680.

In yet another alternative exemplary scenario, the input 1610 may be related to a user experience and may be processed by the experience generator 1670. The experience generator 1670 may provide experience candidates to input to the narrative generator 1680. In any case, the narrative generator 1680 may select a narrative and provide it to a message module 1690 which presents the narrative to the user.

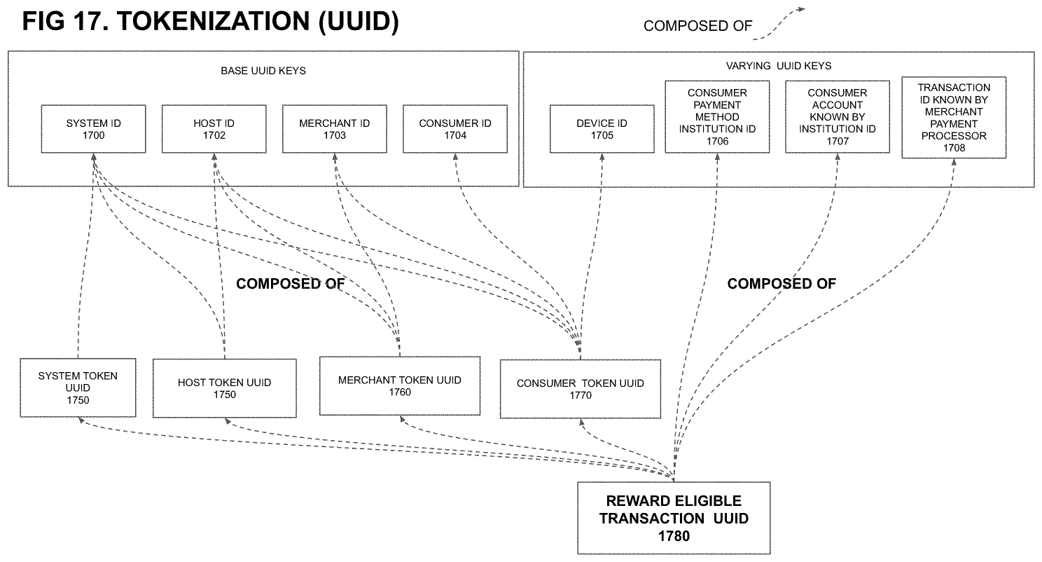

Referring now to FIG. 17, FIG. 17 may be a schematic flowchart illustrating an exemplary tokenization module. Universally unique identifiers (UUID) may be implemented throughout the system. For example, a system ID 1700 may be composed of at least one of a system token UUID 1740, a host token UUID 1750, a merchant token UUID 1760, and a consumer token UUID 1770. An exemplary host ID 1702 may be composed of one or more of a host token UUID 1750, a merchant token UUID 1760, and a consumer token UUID 1770. An exemplary merchant ID 1703 may be composed of one or more of a merchant token UUID 1760, and a consumer token UUID 1770. An exemplary consumer ID 1704 may be composed of a consumer token UUID 1770. The system ID 1700, host ID 1702, merchant ID 1703, and consumer ID 1704 may be categorized as the base UUID keys. These UUID keys may remain static throughout an exemplary system. Varying UUID keys may include a device ID 1705, a consumer payment method institution ID 1706, a consumer account known by institution ID 1707, and a transaction ID known by a merchant payment processor 1708. All of the above IDs and UUIDs may be used to create a reward eligible transaction UUID 1780.

The present invention may present unique advantages over present advertising methods. By implementing artificial intelligence methods, the system may present promotions to fewer consumers without sacrificing the number of purchases produced per advertisement. By advertising to fewer consumers, each of which are more likely to purchase, processing time may decrease, and the computer's efficiency may increase. Further, the consumer experience feed and the narrative module may automatically create effective and personalized marketing advertisements that are directed at relevant consumers. Traditional advertising methods cannot produce individualized advertisements in the same amount of time or in the same capacity as the system. Further, traditional advertising methods may not identify the correct target demographic, and computer resources are often wasted on irrelevant advertisements. This system prevents such waste by only providing advertisements that are relevant and have a high likelihood of success. Thus, the present invention may save significant processing time and resources.

What is claimed is:

1. A system for facilitating a market and transactions between one or more consumers and one or more merchants, comprising:
an enrollment module comprising identifying information relating to consumers and merchants;
a customer identification module, wherein the customer identification module identifies a purchase pattern information related to a consumer and produces one or more personal clusters,
a hyper-personalized matching module, the matching module configured to analyze the purchase pattern information and personal clusters to identify one or more relevant promotions;
a consumer experience feed configured to present the one or more relevant promotions to the consumer based on a plurality of information extracted from the consumer;
a purchase matching module configured to analyze financial data from a bank account belonging to the consumer to identify one or more purchases made by the consumer associated with the one or more relevant promotions;
a reward settlement module configured to apply the relevant promotions to the account of the user by removing funds from the account of the merchant.

2. The system for facilitating a market and transactions of claim 1, wherein the identifying information relating to merchants identifies at least one of a merchant trade, a merchant service, a business type, a location, a picture, and a unique identifier corresponding to the merchant.

3. The system for facilitating a market and transactions of claim 1, wherein the identifying information relating to consumers identifies at least one of a credit card number and a user credential for a bank corresponding to the consumer.

4. The system for facilitating a market and transactions of claim 1, wherein the consumer experience feed comprises textual and visual items, the textual and visual items comprising at least one of a narrative, a purchase feed, a historical feed, and a promotion detail.

5. The system for facilitating a market and transactions of claim 4, wherein the narrative selects at least one of a fact or an experience relating to one consumer.

6. The system for facilitating a market and transactions of claim 5, wherein the narrative implements natural language processing and natural language generation, and integrates information from one or more external sources, and wherein the narrative is structured as a sentence comprising a fact, an experience, and a promotion.

7. The system for facilitating a market and transactions of claim 6, wherein the natural language processing identifies a sentiment model, extracts adjectives, and classifies emotions related to the consumer based on information.

8. The system for facilitating a market and transactions of claim 4, wherein the purchase feed comprises a list of past and pending transactions relating to one consumer and spending information corresponding to the past and pending transactions, wherein the spending information further includes information related to spending in one or more categories.

9. The system for facilitating a market and transactions of claim 4, wherein the historical feed comprises one or more photos taken by the consumer, wherein the photos were taken in proximity to one or more merchant venues.

10. The system for facilitating a market and transactions of claim 4, wherein the promotion detail comprises a profile associated and/or created by a merchant in the enrollment module.

11. A method for facilitating a market and transactions between one or more consumers and one or more merchants, comprising:
enrolling at least one merchant and at least one consumer, wherein the merchant and the consumer enter a plurality of information including at least bank account information;
identifying one or more purchase patterns of the consumer;
compiling the purchase patterns into one or more personal clusters;
matching the consumer to one or more relevant promotions, the relevant promotions being created by the merchant for marketing purposes, wherein the promotions are selected based on the purchase patterns of the consumer;
presenting the relevant promotions to the consumer based on a plurality of information extracted from the consumer.

12. The method for facilitating a market and transactions of claim 11, wherein the step of identifying one or more purchase patterns of the consumer further comprises:
extracting a set of metadata from one or more photos from a consumer device, the set of metadata corresponding to time and location data associated with the consumer;
extracting a purchase transaction history relating to a consumer from a financial aggregator;
categorizing the purchase transaction history to identify a monthly spending in each one of a plurality of purchase categories;
identifying one or more venues from the purchase transaction history and identifying venue data, the venue data comprising at least one of a name, address, geolocation, rating, operating hours, and price level corresponding to the one or more venues;
generating one or more multi-dimensional maps for each identified purchase category based on the metadata, purchase transaction history, venue location, and venue information data
updating the identified purchase patterns based on the metadata, purchase transaction history, and venue data.

13. The method for facilitating a market and transactions of claim 12, further comprising storing a resulting matched promotion and information related to the matched promotion.

14. The method for facilitating a market and transactions of claim 12, further comprising:
transforming the multi-dimensional maps into a set of geoclusters, wherein each cluster is based on a physical location where the consumer spends an amount of time.
identifying behavioral patterns of the consumer based on the geoclusters to identify frequently visited locations and labeling each of the locations;
building a consumer interest cluster based on each geocluster, each consumer interest cluster comprising at least one of a geolocation radius, an amount of time spent at the location, days of the week spent in the geocluster, and a mode of transport;
correlating a consumer purchase history with the consumer interest cluster; and
updating the purchase patterns based on the consumer interest clusters.

15. The method for facilitating a market and transactions of claim 14, wherein each multi-dimensional map is associated with a location where the consumer visits.

16. A computer program product for marketing using one or more promotions, comprising:
an enrollment module, wherein the enrollment module receives an identifying information from a plurality of consumers and an identifying information from one or more merchants, including at least bank information;
a customer identification module, wherein the customer identification module extracts and analyzes a set of data related to each of the plurality of consumers to produce a purchase pattern associated with each consumer; wherein each purchase pattern is further presented as one or more personal clusters, each personal cluster representing an area where the consumer frequently visits;
a personalized matching module, wherein the matching module compares the purchase pattern and personal clusters to the promotions to identify one or more relevant promotions;
a consumer experience feed, wherein the consumer experience feed presents the one or more relevant promotions to the consumers based on a plurality of information extracted from the consumer;
a purchase matching module, wherein the purchase matching module extracts financial data from the consumer to identify one or more relevant purchases associated with the relevant promotions;
a reward settlement module, wherein the reward settlement module applies the relevant promotions to an account associated with the consumer by removing funds from an account associated with the merchant.

17. The computer program product of claim 16, further comprising a consumer promotion search module, wherein the search module identifies relevant promotions based on one or more search terms curated by one consumer.

18. The computer program product of claim 17, wherein the search terms include at least one of a venue name, a category, and a type of business.

19. The computer program product of claim 17, wherein the search module displays relevant promotions on a map.

20. The computer program product of claim 16, further comprising a tokenization module, wherein each merchant and each consumer each have a universally unique identifier.
